(19) United States
(12) Patent Application Publication
(10) Pub. No.: US 2015/0380155 A1
(43) Pub. Date: Dec. 31, 2015

(54) COIL ASSEMBLY FOR AN ENGINE

(71) Applicant: Perkins Engines Company Limited, Peterborough (GB)

(72) Inventor: Veera S. Kanithi, Chennai (IN)

(73) Assignee: Perkins Engines Company Limited, Peterborough (GB)

(21) Appl. No.: 14/852,612

(22) Filed: Sep. 13, 2015

(51) Int. Cl. H01F 27/28

(52) U.S. Cl. CPC H01F 27/2823

(57) ABSTRACT

A coil assembly for electrically connecting a spark plug with an ignition system for a combustion engine having a cylinder head is provided. The coil assembly includes an electrical transducer member having an elongate portion and a head portion. The coil assembly also includes a sleeve structured and arranged to support and seal the electrical transducer member from an ambient environment. A first end of the sleeve defines a sealing groove. The sleeve also includes a shoulder portion defined at the first end. The shoulder portion of the sleeve is in an abutment relationship with the step in the cylinder head coinciding with an assembled state of the sleeve with the cylinder head. The coil assembly further includes a sealing member received within the sealing groove of the sleeve. The head portion of the electrical transducer member is sealed with the second end of the sleeve in the assembled state.

### TECHNICAL FIELD

The present disclosure relates to a coil assembly for electrically connecting a spark plug with an ignition system for a combustion engine.

### BACKGROUND

Typically, ignition system of an engine is connected to a spark plug to precisely initiate a combustion process in a combustion chamber. Such a spark plug is mounted on a cylinder head of the engine such that its electrodes are positioned inside the combustion chamber of the engine. The spark plug is provided with high voltage electricity from the ignition system of the engine to generate an ignition spark between electrodes of the spark plug. Such ignition system includes a power source connected to the spark plug. The spark plug can be connected to the power source by making use of various electric components, such as an ignition coil, a power distributor, power cables, etc. A reliable and secure connection is essential between the spark plug and such electrical components.

Such electrical components, such as ignition coil, can also be directly mounted on the cylinder head. Directly mounted ignition coils provide numerous advantages such as elimination of high voltage leads, elimination of waste spark and packaging benefits. However, such electrical components when exposed to a surrounding of the engine and high temperature of cylinder head can get damaged and thus, resulting in failure of the ignition system.

U.S. Pat. No. 5,363,046 (the '046 patent) discloses a spark plug cap with misfire detecting capacitor for internal combustion engine. The spark plug cap includes a capacitor for detecting ignition voltage of an internal combustion engine to determine if misfire occurs. The spark plug cap covers terminal of a spark plug and has a conductor for carrying ignition voltage current from an ignition coil to spark plug terminal to generate an electronic spark between spark plug electrodes and an insulator surrounding the conductor. In the spark plug cap, a second conductor is located around the first conductor keeping a predetermined distance form the first conductor such that a capacitor, which constitutes a capacitance divider with a capacitor for ignition voltage detection, is formed between the first and the second conductors. A ceramic insulator can be positioned between the first and the second conductors to provide higher insulation property. However, the spark plug cap, as disclosed in the '046 patent, has multiple components which can increase a cost and design complexity.

### SUMMARY OF THE DISCLOSURE

In an aspect of the present disclosure, a coil assembly for electrically connecting a spark plug with an ignition system for a combustion engine having a cylinder head is provided. The cylinder head defines a recess therein. The recess includes a first portion and a second portion defining a step adjacent to the first portion. The coil assembly includes an electrical transducer member having an elongate portion and a head portion disposed over the elongate portion and connected to the elongate portion. The coil assembly also includes a sleeve defining a first end and a second end. The first end of the sleeve defines a sealing groove disposed on an outer surface. The sleeve includes a sealing portion disposed on the second end of the sleeve. The sleeve also includes a shoulder portion. The shoulder portion is defined at the first end of the sleeve. The coil assembly further includes a sealing member received within the sealing groove of the sleeve. Further, the second end of the sleeve is selectively connectable within the recess of the cylinder head. The shoulder portion of the sleeve is in an abutment relationship with the step in the cylinder head coinciding with an assembled state of the sleeve with the cylinder head. The head portion of the electrical transducer member is sealed with the second end of the sleeve in the assembled state. Further, the sleeve is structured and arranged to support and seal the electrical transducer member from an ambient environment.

Other features and aspects of this disclosure will be apparent from the following description and the accompanying drawings.

### BRIEF DESCRIPTION OF THE DRAWINGS

FIG. 1 is a perspective view of an exemplary engine having multiple coil assemblies in vicinity of engine cylinders, in accordance with embodiments of the present disclosure;

FIG. 2 is a partial sectional view of the engine of FIG. 1, in accordance with an embodiment of the present disclosure;

FIG. 3 is a sectional view of the coil assembly of FIG. 2 with a sleeve in an assembled state, in accordance with an embodiment of the present disclosure; and

FIG. 4 is an exploded view of the coil assembly of FIG. 2, in accordance with an embodiment of the present disclosure.

### DETAILED DESCRIPTION

Reference will now be made in detail to specific embodiments or features, examples of which are illustrated in the accompanying drawings. Wherever possible, corresponding or similar reference numbers will be used throughout the drawings to refer to the same or corresponding parts.

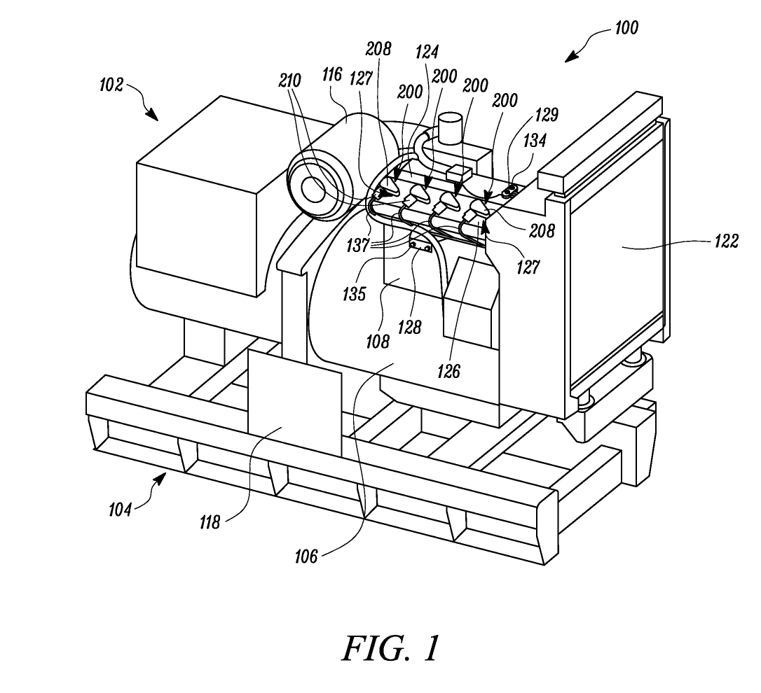

FIG. 1 shows a perspective view of an exemplary combustion engine 100 having multiple coil assemblies 200. The combustion engine 100, as disclosed herein, is an internal combustion engine. The combustion engine 100 can be configured to operate using fuels such as, but not limited to, gasoline, Natural Gas, Liquefied Petroleum Gas (LPG), and bio-fuels. The combustion engine 100 can be used as a source of power for any machine or other devices, such as, on-highway trucks or vehicles, pumps, stationary equipment, generators, etc.

The combustion engine 100 can be of a multi-cylinder type (as shown), or a single cylinder engine. Moreover, the combustion engine 100 can be of a V-type configuration, an in-line configuration, or a radial configuration. A person of ordinary skill in the art will appreciate that embodiments of the present disclosure can be beneficially implemented in various types of engines commonly known in the art without deviating from the spirit of the present disclosure. As shown in FIG. 1, the combustion engine 100 provides power to a power conversion device 102. The power conversion device 102 can include a generator, transmission device, a hydraulic pump, and the like. The combustion engine 100 and the power conversion device 102 are mounted on a frame 104. The frame 104 can be coupled to a chassis of a machine (not shown). Alternatively, the frame 104 can be disposed on ground.

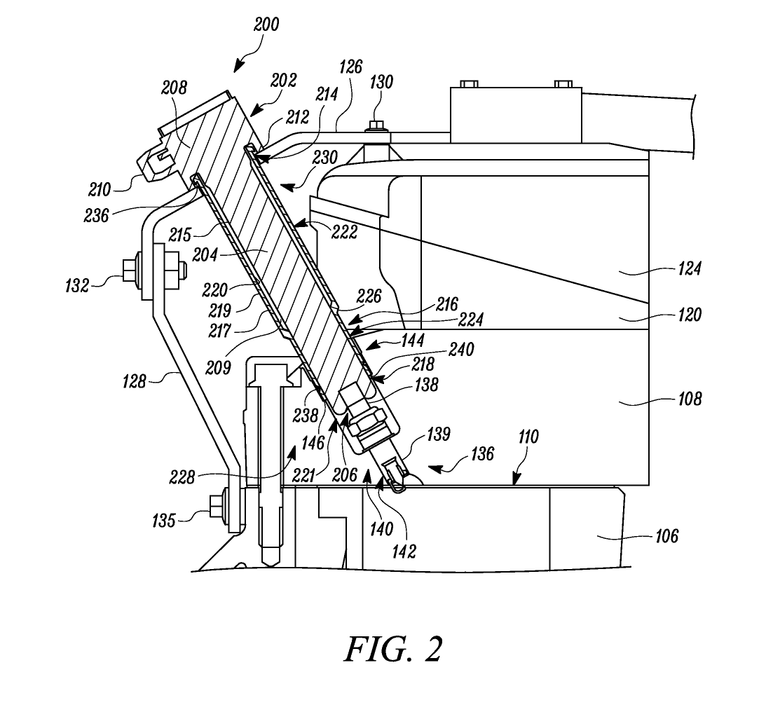

As shown in FIG. 1, the combustion engine 100 is an in-line LPG based combustion engine. The combustion engine 100 includes a cylinder block 106 and a cylinder head 108 mounted on the cylinder block 106. The cylinder block 106 is mounted on the frame 104. The cylinder block 106 also supports a crankshaft (not shown). The cylinder block 106 includes one or more cylinders 110 (only one cylinder is shown in FIG. 2). Each of the cylinders 110 receives a piston (not shown). Further, each of the cylinders 110 receives a supply of fuel via a throttle (not shown). Each of the cylinders 110 can also be provided with one or more fuel injectors (not shown) to deliver a pressurized supply of fuel, for example, LPG.

Further, the cylinder head 108 encloses the cylinders 110 such that one or more combustion chambers (not shown) are defined within the each of the cylinders 110 positioned between the cylinder head 108 and the cylinder block 106. The cylinder head 108 also includes one or more intake ports (not shown) and/or exhaust ports (not shown). The intake ports are disposed in fluid communication with the one or more cylinders 110. The combustion engine 100 further includes an intake manifold (not shown) coupled to the intake ports to supply a mixture of gaseous fuel and air into each of the cylinders 110. The combustion engine 100 also includes an air filter 116 disposed in fluid communication with the intake ports.

Further, each of the exhaust ports is in fluid communication with a corresponding cylinder 110 to discharge exhaust gas from the corresponding cylinder 110. An exhaust manifold (not shown) is connected to the exhaust ports to discharge the exhaust gas. The combustion engine 100 is further communicably coupled to an Electronic Control Module (ECM) 118. Referring to FIG. 1, the ECM 118 is mounted on the frame 104. However, in various applications, the ECM 118 can be mounted on a panel or an enclosure spaced near to the combustion engine 100. The ECM 118 communicates with one or more sensors, such as a crankshaft rotational speed sensor, of the combustion engine 100. The ECM 118 also receives signals from the sensors and correspondingly controls one or more components of the combustion engine 100.

Further, the combustion engine 100 is coupled a heat exchanging device 122. The heat exchanging device 122 is provided to cool the combustion engine 100. The heat exchanging device 122 receives coolant from an engine cooling system (not shown) of the combustion engine 100. The heat exchanging device 122 can include multiple tubes in order to control a temperature of the combustion engine 100. Although not shown, the combustion engine 100 also includes other components, such as, a fuel system, an intake system, a crankcase, a flywheel, gas mixer, throttle, gas train system and so on.

The combustion engine 100 includes a rocker arm bracket 120 mounted on the cylinder head 108. The rocker arm bracket 120 supports multiple rocker arms (not shown). The combustion engine 100 further includes a top cover 124 mounted on the rocker arm bracket 120. The top cover 124 is provided to enclose and seal various parts of the combustion engine 100 from an ambient environment. The combustion engine 100 further includes a first bracket 126, a second bracket 128 mounted on the cylinder block 106, and a support bracket 129 coupled to the heat exchanging device 122. The first bracket 126 is mounted on the top cover 124 via fasteners 130 (shown in FIG. 2). The first bracket 126 is also mounted on the second bracket 128 via fasteners 132 (shown in FIG. 2). The first bracket 126 is further coupled to the support bracket 129 via fasteners 134. The second bracket 128 is mounted on the cylinder block 106 via fasteners 135.

The first bracket 126 and the second bracket 128 are structured and arranged to support each of the coil assemblies 200. The first bracket 126 includes multiple openings 127 adapted to seat each of the coil assemblies 200. As shown in FIG. 1, the first bracket 126 includes four such openings 127.

The combustion engine 100 further includes an ignition system (not shown) provided to initiate combustion in the cylinders 110. Specifically, the ignition system supplies an electric current to one or more spark plugs 136 (only one shown in FIG. 2) installed in the cylinder head 108. The ignition system can include a source (not shown) of electrical energy, for example a battery, connected to a distributor (not shown) by means of one or more cables 137. The source provides a direct current. An alternator may also be provided to convert direct current from the source to alternating current. Further, the distributor receives an electric current from the source and transfer to each of the spark plugs 136. Alternatively, the ignition system can be a direct ignition system. In such a case, a coilpack having multiple coils transfers electric current from the source to each of the spark plugs 136.

Further, the spark plugs 136 are provided in each of the cylinders 110 to generate a spark within a corresponding combustion chamber. Each of the spark plugs 136 includes a spark generating portion (not shown) adapted to generate the spark within a corresponding combustion chamber. The spark generating portion can include one or more electrodes which upon receiving high voltage current generate a spark. The spark generating portion is further coupled to a body 139 of the spark plug 136. The spark plug 136 also includes a plug connecting portion 138 mounted on the body 139. The plug connecting portion 138 can include electrical terminals to receive the flow of an electric current.

Referring to FIG. 2, a partial sectional side view of the cylinder head 108 is illustrated. The cylinder head 108 defines a recess 140 adjacent to the cylinder 110. The recess 140 is aligned with each of the openings 127 of the first bracket 126 such that the recess 140 partly receives the coil assembly 200 within the cylinder head 108. The recess 140 includes a first portion 142 which is positioned near the cylinder 110. The first portion 142 partly receives the spark plug 136 such that the spark generating portion of the spark plug 136 is positioned within the cylinder 110. Further, the body 139 of the spark plug 136 is positioned within the first portion 142 of the recess 140.

The recess 140 also includes a second portion 144 positioned distal to the cylinder 110. The second portion 144 is positioned distal to the cylinder 110. The second portion 144 defines a step 146 adjacent to the first portion 142. As shown in FIG. 2, the second portion 144 of the recess 140 receives the plug connection portion 138 of the spark plug 136.

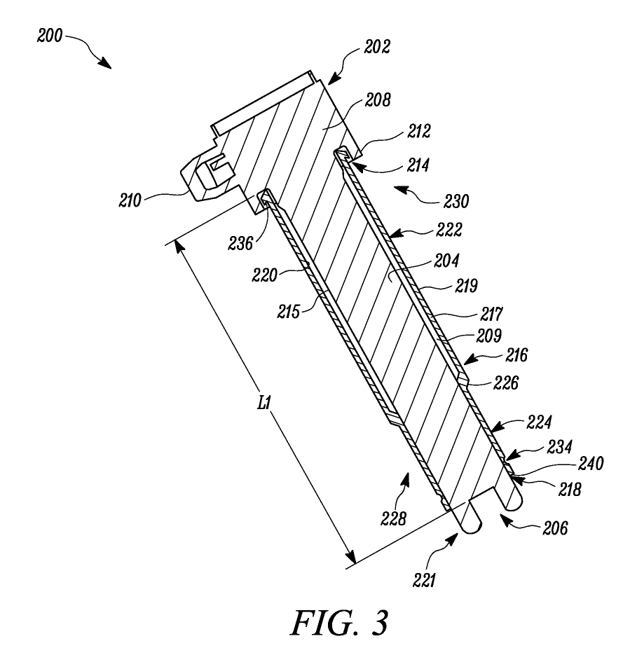

Referring to FIGS. 2 and 3, the coil assembly 200 for electrically connecting the spark plug 136 with the ignition system of the combustion engine 100 is illustrated. The coil assembly 200 includes an electrical transducer member 202. The electrical transducer member 202 is an ignition coil configured to receive a supply of electric current form the source at amperage ‘A’. The ignition coil is further configured supply an electric current at an amperage greater than the amperage ‘A’ to the spark plug 136. The electrical transducer member 202 includes an elongate portion 204. The elongate portion 204 can enclose one or more components, such as conductor coil windings, adapted to step up a voltage of electric current flowing therethrough. The elongate portion 204 is cylindrical in shape having a first segment and a second segment. A diameter of the first segment is greater than a diameter of the second segment. The elongate portion 204 further defines a cavity 206 at an end thereof. The elongate portion 204 can include one or more electrical terminals (not shown) within the cavity 206. The electrical terminals are provided to connect the coil windings provided within the elongate portion 204 with the spark plug 136.

The electrical transducer member 202 further includes a head portion 208 disposed over and connected to the elongate portion 204. The head portion 208 can enclose one or electrical connectors which can receive the flow of electrical current, via cables 137 (shown in FIG. 1), from the source and supply the flow of electric current to the coil windings. The head portion 208 includes a receptacle portion 210. The receptacle portion 210 encloses one or more snap fit type electrical connectors.

Further, a diameter of the head portion 208 is greater than the diameter of the elongate portion 204 such that a flange 212 is defined between the head portion 208 and the elongate portion 204. The flange 212 supports the coil assembly 200 on the first bracket 126 (shown in FIG. 1) of the combustion engine 100. The head portion 208 further defines a connecting groove 214 defined between the flange 212 and a surface 215 of the elongate portion 204.

The coil assembly 200 further includes a sleeve 216. The sleeve 216 supports and seals the electrical transducer member 202. A material of the sleeve 216 can include steel and nylon. The sleeve 216 includes a wall 217 defining a space 218 within the sleeve 216. The wall 217 further defines an outer surface 219 and an inner surface 220 extending along a length of the sleeve 216. As shown in FIG. 3, the space 218 partly receives the elongate portion 204 of the electrical transducer member 202 such that the sleeve 216 is disposed around the elongate portion 204 of the electrical transducer member 202. The sleeve 216 is disposed around the elongate portion 204 along a length ‘L1’ extending between the head portion 208 and an end 221 of the elongate portion 204.

The sleeve 216 further includes an upper portion 222, a lower portion 224 and an intermediate portion 226 positioned between the upper portion 222 and the lower portion 224. The inner surface 220 of the lower portion 224 is spaced apart from the outer surface 215 of the elongate portion 204 such that a gap is defined therebetween. The gap facilitates disengagement of the electrical transducer member 202 from the sleeve 216. A diameter of the upper portion 222 is greater than a diameter of the elongate portion 204 such that a clearance 209 is defined between the inner surface 220 of the sleeve 216 and the surface 215 of the elongate portion 204. Further, the intermediate portion 226 is inclined with respect to the upper and lower portions 222, 224.

The sleeve 216 further defines a first end 228 and a second end 230. The first end 228 of the sleeve 216 defines a sealing groove 234. The sealing groove 234 is disposed around the outer surface 219 at the first end 228 of the sleeve 216. Further, the second end 230 of the sleeve 216 is connectable within the recess 140 of the cylinder head 108.

The sleeve 216 also includes a sealing portion 236 disposed on the second end 230. As shown in FIG. 3, the sealing portion 236 is a projection which is received within the connecting groove 214 of the elongate portion 204 such that the sealing portion 236 seals the electrical transducer member 202. Further, the coil assembly 200 includes a sealing member 238 (shown in FIG. 2) positioned within the sealing groove 234 of the sleeve 216. The sealing member 238 is an O-ring disposed around a circumference of the sealing groove 234.

Referring to FIGS. 2 and 3, an assembled state of the sleeve 216 of the coil assembly 200 with the cylinder head 108 is illustrated. In the assembled state of the sleeve 216, the coil assembly 200 is partly received within the recess 140 of the cylinder head 108 such that the electrical transducer member 202 is mounted on the spark plug 136. Specifically, the cavity 206 of the elongate portion 204 receives the plug connecting portion 138 of the spark plug 136. The electrical terminals of the electrical transducer member 202 can be connected with the plug connecting portion 138 of the spark plug 136 via a connection spring (not shown). The connection spring can be an electrical conducting coil spring. In such a case, a gap between the second end 230 of the electrical transducer member 202 and the plug connecting portion 138 of the spark plug 136 can also be provided.

Further, the head portion 208 of the electrical transducer member 202 is supported on the first bracket 126 (shown in FIG. 1). The head portion 208 of the electrical transducer member 202 is mounted on the first bracket 126 via fasteners (not shown).

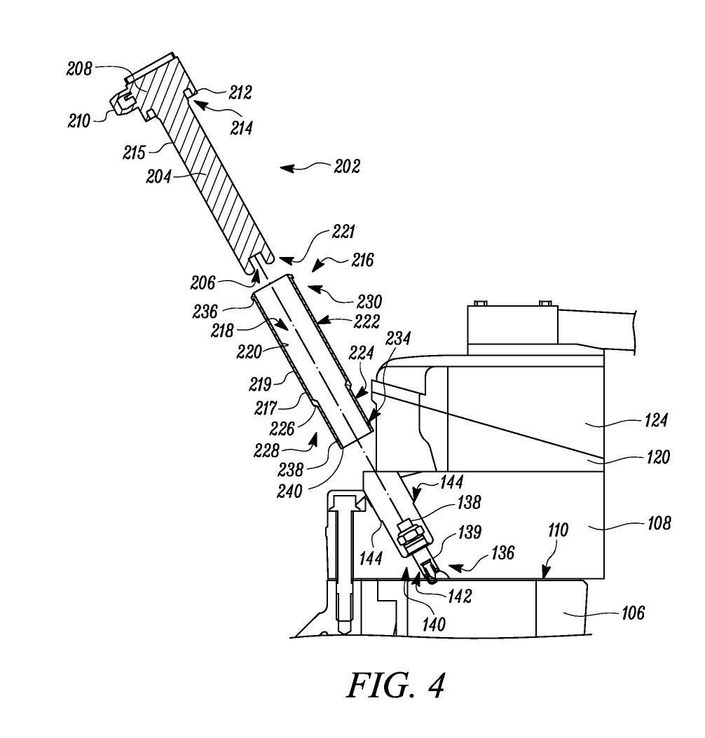

Referring to FIG. 4, the sleeve 216 of the coil assembly 200 is received within the recess 140 such that the sleeve 216 supports and seals the electrical transducer member 202. Specifically, a section of the elongate portion 204 of the electrical transducer member 202 extending out of the cylinder head 108 is completely enclosed by the upper portion 222 of the sleeve 216. Also, the lower portion 224 of the sleeve 216 is positioned within the second portion 144 of the recess 140. The outer surface 219 of the lower portion 224 of the sleeve 216 abuts the recess 140. Further, the sealing member 238 is disposed within the sealing portion 236 at the first end 228 of the sleeve 216 such that the sealing member 238 seals the electrical transducer member 202.

The sleeve 216 further includes a shoulder portion 240 defined at the second end 230 of the sleeve 216. The shoulder portion 240 of the sleeve 216 is in an abutment relationship with the step 146 in the cylinder head 108. The shoulder portion 240 engages with the step 146 of the recess 140 such that a movement of the coil assembly 200 is minimized.

### INDUSTRIAL APPLICABILITY

The present disclosure is related to the coil assembly 200 for electrically connecting the spark plug 136 with the ignition system for the combustion engine 100. As described above, the coil assembly 200 includes the electrical transducer member 202, the sleeve 216 and the sealing member 238 to connect the spark plug 136 with the source. The sleeve 216 is disposed around the elongate portion 204 of the electrical transducer member 202 such that a portion of the elongate portion 204 extending out of the cylinder head 108 is completely enclosed by the sleeve 216. The sealing portion 236 of the sleeve 216 is received within the connecting groove 214 of the head portion 208 of the electrical transducer member 202. Further, the shoulder portion 240 abuts the step 146 of the recess 140 such that the movement of the coil assembly 200 towards the cylinder 110 is minimized. Hence, the electrical transducer member 202 can be properly connected with the spark plug 136.

Further, the sealing member 238 is disposed within the sealing groove 234 of the sleeve 216 to prevent foreign materials such as, dust, smoke, etc., from entering the combustion chamber of the cylinder 110. The sleeve 216 also protects the electrical transducer member 202 from high temperature of the cylinder head 108. Thus, a secure connection between the coil assembly 200 and the spark plug 136 can be obtained. Further, design and use of the sleeve 216 can be simple and economical.

As described above, the coil assembly 200 is partly received within the recess 140 defined in the cylinder head 108. The coil assembly 200 can also be installed in pre-defined recess, such as a glow plug recess in diesel engines. In such a case, a diesel engine can be modified to receive the coil assembly 200 and converted to an LPG engine. Hence, the coil assembly 200 can be conveniently retrofittable with existing engines.

While aspects of the present disclosure have been particularly shown and described with reference to the embodiments above, it will be understood by those skilled in the art that various additional embodiments can be contemplated by the modification of the disclosed machines, systems and methods without departing from the spirit and scope of what is disclosed. Such embodiments should be understood to fall within the scope of the present disclosure as determined based upon the claims and any equivalents thereof.

What is claimed is:

1. A coil assembly for electrically connecting a spark plug with an ignition system for a combustion engine having a cylinder head defining a recess therein, the recess having a first portion and a second portion defining a step adjacent to the first portion, the coil assembly comprising:
an electrical transducer member including an elongate portion, and a head portion disposed over the elongate portion and connected to the elongate portion;
a sleeve defining a first end and a second end, the first end of the sleeve defining a sealing groove disposed on an outer surface of the first end of the sleeve thereof; the sleeve including:
a sealing portion disposed on the second end of the sleeve, and a shoulder portion being defined at the first end of the sleeve; and
a sealing member received within the sealing groove of the sleeve;
wherein the second end of the sleeve being selectively connectable within the recess of the cylinder head and the shoulder portion of the sleeve being in an abutment relationship with the step in the cylinder head coinciding with an assembled state of the sleeve with the cylinder head;
wherein the head portion of the electrical transducer member being sealed with the second end of the sleeve in the assembled state; and
wherein the sleeve being structured and arranged to support and seal the electrical transducer member from an ambient environment.
